(19) United States
(12) Patent Application Publication
(10) Pub. No.: US 2012/0123917 A1
(43) Pub. Date: May 17, 2012

(54) SYSTEM AND METHOD FOR VARIABLE TIME-BASED LICENSING

(75) Inventors: Yorgos Koutsoyannopoulos, Athens (GR); Anand Raman, Campbell, CA (US); Sotirios Bantas, Athens (GR); Apostolos Liapis, Athens (GR); Christos Makiyama, Yokohama (JP); Nikolas Provatas, Piraeus (GR)

(73) Assignee: HELIC S.A., Athens (GR)

(21) Appl. No.: 13/105,772

(22) Filed: May 11, 2011

Related U.S. Application Data
(60) Provisional application No. 61/346,346, filed on May 19, 2010.

(51) Int. Cl. G06Q 10/00

(52) U.S. Cl. 705/30

(57) ABSTRACT

A system and method for variable time-based licensing is provided, which includes a chips cache which stores activated chips and a chips pool which stores inactive chips. In this context “chips” can be considered a currency which can be traded to use software tools for a period of time associated with each chip. The system further includes a chips accounting manager, operable to receive license requests for software tools and to determine whether to grant the license request; and a license manager which tracks active chips and manages activated chip check-in and checkout. When the chips accounting manager receives a license request for a software tool the chips accounting manager determines whether the chips cache includes sufficient chips to access the software tool. If there are insufficient chips, the chips accounting manager checks whether inactive chips in the chip pool can be activated and added to the chips cache. If there are sufficient chips, the chips accounting manager notifies the license manager to check out the sufficient chips from the chips cache and grant access to the software tool.

### CLAIM OF PRIORITY

This application claims the benefit of priority to U.S. Provisional Patent application titled “SYSTEM AND METHOD FOR VAIABLE TIME-BASED LICENSING”, Application No. 61/346,346, filed May 19, 2011, and incorporated herein by reference.

### COPYRIGHT NOTICE

A portion of the disclosure of this patent document contains material which is subjected to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

Embodiments of the present invention are generally related to electronic design automation (EDA) software licensing and license managers, and particularly to a system and method for variable time-based licensing in an EDA or other environment.

### BACKGROUND

Electronic Design Automation (EDA) tools are software tools used to design electronic systems including chips and circuits. Traditionally, circuit design firms would purchase EDA tools, like most software tools, outright. This model, in which the EDA tool is viewed as an asset, has been subsequently largely replaced by a time-based license (TBL) model, in which the EDA tool was essentially leased to the design firm. A design firm would purchase licenses from the EDA tool developer and then allocate these licenses for use among the design firms various development teams. As long as a license was available, a user in the firm could access the software as needed and then return the license to a license pool so that other users in the firm could use the software.

However, a firm's design cycle often does not yield uniform usage of EDA tools. Instead, a firm may experience periods where no licenses are used, and other periods where there is demand for additional licenses above the number of licenses purchased. Thus, design firms generally plan to purchase enough licenses to satisfy average demand over the course of a contract period (e.g., a year), to attempt to minimize both the losses associated with underutilized licenses and the inconvenience associated with increased demand during peaks of the design cycle.

FIG. 1 shows a chart of Concurrent Licenses Used under the TBL Model as a function of time. In the example of FIG. 1, the curve 100 illustrates the number of licenses used (or demanded) at any given time, while number of licenses purchased is represented by dotted line 102. The area under the curve 104 represents the time during which the EDA tools are actually being utilized. Over the course of the exemplary design cycle shown in FIG. 1, there are two peak periods 106 in which demand for licenses exceeds the number of licenses purchased, resulting in unfulfilled demand. Additionally, there is one period 108 during which all licenses are sitting idle.

It is clear that the TBL model which currently dominates the EDA software market produces inefficiencies for both the customer and the software developer by providing coarse grained controls that cannot be easily adapted to the natural design cycles of design firms.

### SUMMARY

In accordance with an embodiment, a system and method for variable time-based licensing is provided, which includes a chips cache which stores activated chips and a chips pool which stores inactive chips. In this context “chips” can be considered a currency which can be traded to use software tools for a period of time associated with each chip. The system further includes a chips accounting manager, operable to receive license requests for software tools and to determine whether to grant the license request; and a license manager which tracks active chips and manages activated chip check-in and checkout. When the chips accounting manager receives a license request for a software tool the chips accounting manager determines whether the chips cache includes sufficient chips to access the software tool. If there are insufficient chips, the chips accounting manager checks whether inactive chips in the chip pool can be activated and added to the chips cache. If there are sufficient chips, the chips accounting manager notifies the license manager to check out the sufficient chips from the chips cache and grant access to the software tool.

### BRIEF DESCRIPTION OF THE FIGURES

FIG. 1 shows a chart of Concurrent Licenses Used under the TBL Model as a function of time.

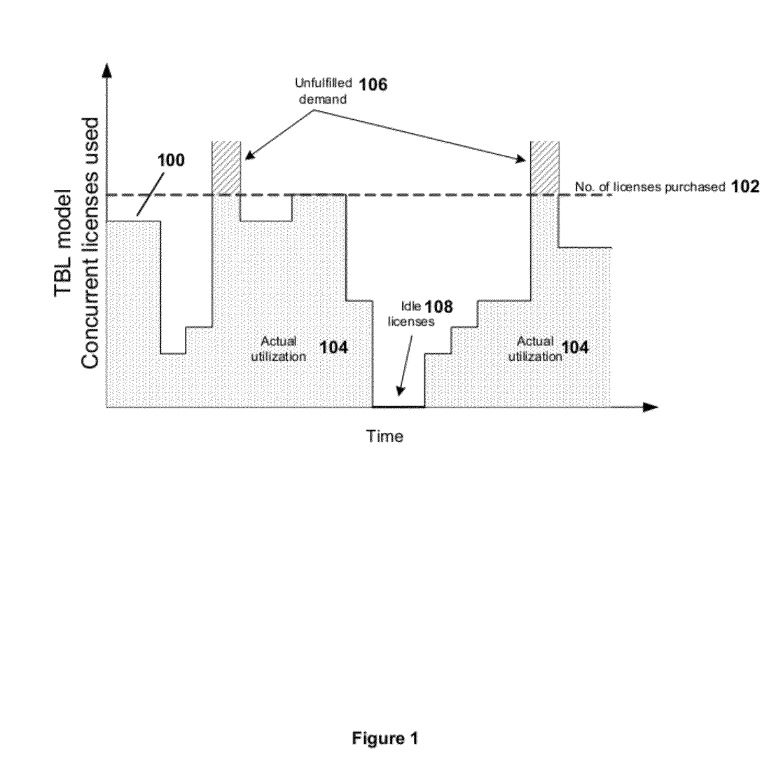

FIG. 2 shows a chart of Concurrent Licenses Used for a High Speed Modeling (HSM) Tool under the TBL Model as a function of time.

FIG. 3 shows a block diagram of a VTBL system, in accordance with an embodiment.

FIG. 4 shows a flow chart illustrating a method of managing chips by a chips accounting manager, in accordance with an embodiment.

FIG. 5 shows a flow chart illustrating a method of managing chips by a chips accounting manager, in accordance with an embodiment.

FIG. 6 shows an audit function, in accordance with an embodiment.

FIG. 7 shows an exemplary graphical user interface associated with the licensing system, in accordance with an embodiment.

FIG. 8 shows a chips utilization example, in accordance with an embodiment.

FIG. 9 shows an example of a utilization bonus, in accordance with an embodiment.

### DETAILED DESCRIPTION

In accordance with an embodiment, a system and method for variable time-based licensing is provided, which includes a chips cache which stores activated chips and a chips pool which stores inactive chips. In this context “chips” can be considered a currency which can be traded to use software tools for a period of time associated with each chip. The system further includes a chips accounting manager, operable to receive license requests for software tools and to determine whether to grant the license request; and a license manager which tracks active chips and manages activated chip check-in and checkout. When the chips accounting manager receives a license request for a software tool the chips accounting manager determines whether the chips cache includes sufficient chips to access the software tool. If there are insufficient chips, the chips accounting manager checks whether inactive chips in the chip pool can be activated and added to the chips cache. If there are sufficient chips, the chips accounting manager notifies the license manager to check out the sufficient chips from the chips cache and grant access to the software tool.

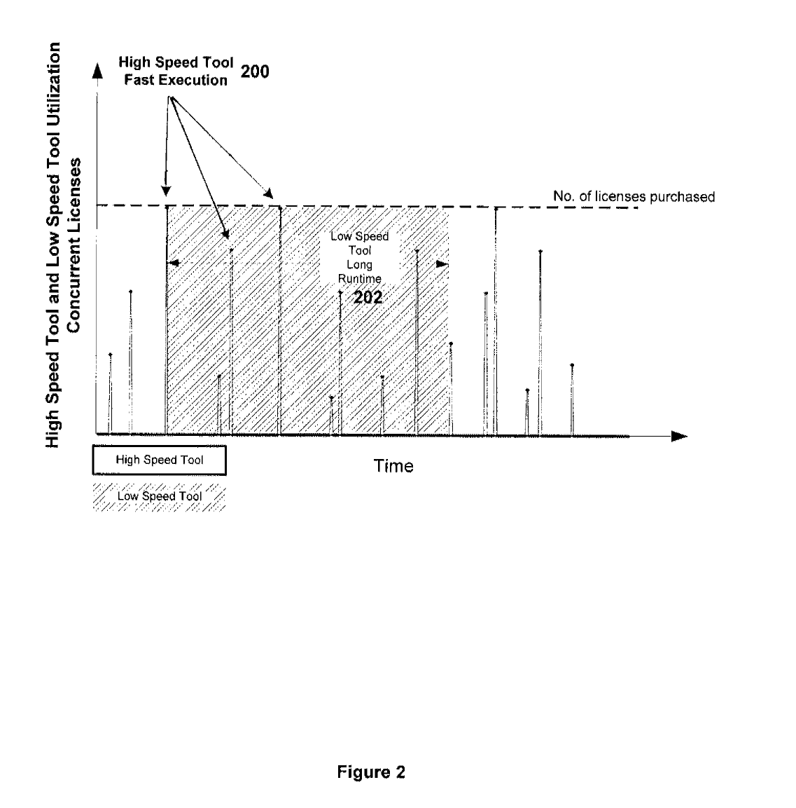

FIG. 2 shows a chart of Concurrent Licenses Used for a High Speed Tool and a Low Speed Tool under the TBL Model as a function of time. As shown in FIG. 2, a high speed tool generally executes more quickly than a traditional low speed tool, so its utilization curve can be seen as a series of brief spikes 200. Performing the same operations using a traditional low speed tool can require a significantly greater utilization period, as illustrated by block 202. Under the TBL model, a firm is incentivized to purchase fewer licenses of the high speed tool over the course of a contract period (e.g., a year), based on the speed at which the high speed tool operates. The TBL model ignores how productive a given tool is and instead only values how often the tool is used. Thus, high speed tools are effectively penalized under TBL as compared to lower speed tools. This applies to any area in which a vendor licenses a tool on a time basis, such as Computer Aided Design (CAD), data analytics and EDA tools, among others.

In accordance with an embodiment, and unlike traditional TBL systems which granted a certain number of licenses that can be used at a given time, a contract for a given contract period (e.g., a year) under a VTBL system can specify a number of chips. Chips can be stored for the contract period until needed by the firm. The chips can then be activated on demand by the firm to access one or more software tools, with each chip expiring after a predetermined time after activation. Each software tool can require a predetermined number of chips to be utilized, depending on factors specific to that software tool such as the complexity of operations that can be performed by the software tool, or the productivity of the software tool.

For example, consider the situation in which firm A wants three of its employees to use Tool 1 to work on a project. Under the TBL system, firm A can check how many licenses it has for Tool 1 and then schedule its employees accordingly (e.g., if they have two licenses they could stagger their employees hours so that only two of the employees are using Tool 1 at any given time). This employment schedule would continue until the project is complete.

However, in accordance with an embodiment, under a VTBL system, firm A can check how many chips Tool 1 requires. For example, if Tool 1 requires one chip per user, and each chip lasts one week, then firm A can allocate three chips so that each of the three employees can work simultaneously. Thus, firm A is not bound by a predetermined number of licenses. When demand increases, they can activate more chips and when demand decreases they can activate fewer chips. Since each chip lasts for a predetermined amount of time (e.g., a week), the amount of time a chip is idle, and therefore wasted, is greatly reduced as compared with TBL.

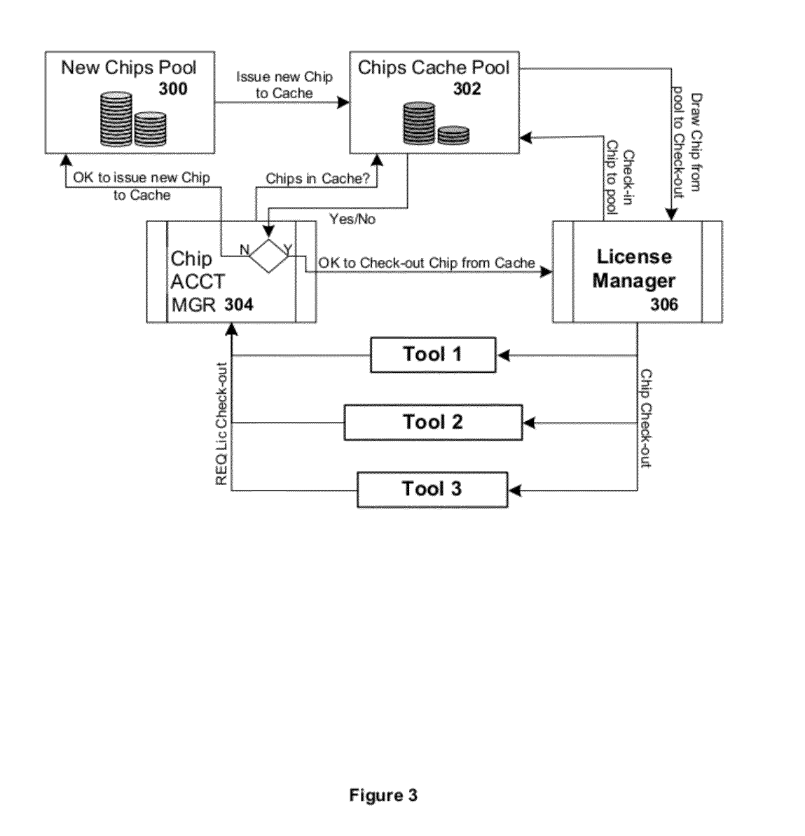

FIG. 3 shows a block diagram of a VTBL system, in accordance with an embodiment. As shown in FIG. 3, a contract can specify a number of chips available to a customer during the contract period. In accordance with an embodiment, the contract period can be any period of time, as specified by the contract. Often contracts are negotiated on a yearly basis, leading to a one year contract period. Chips, or combinations of chips, can be used by the customer to utilize software tools. The chips specified in the contract, referred to as new chips, are stored in a new chips pool 300. These new chips last for the duration of the contract period or until they are consumed.

In accordance with an embodiment, when new chips are consumed, their status changes from new chips to activated chips, and the activated chips are stored in the chips cache pool 302. Once activated, activated chips last for a limited period of time, for example one week. Activated chips, or combinations thereof, can be used to by the customer to use software tools. Once the customer finishes using the software tool, if the activated chips are still active, then they are returned to the chips cache pool and can be used again by the customer to reuse the software tool, or a different software tool.

In accordance with an embodiment, the new chips pool and the chips cache pool can be implemented as a single chip pool which tracks chip consumption and activation, and makes chips available as specified by the contract in view of current consumption.

In accordance with an embodiment, when a customer requests access to a tool (such as tool 1, tool 2, or tool 3) a chips accounting manager 304 checks whether sufficient chips are available in the chips cache pool. If there are sufficient chips, then the chips accounting manager passes the request to the license manager 306 which draws the necessary chips from the chip cache pool and grants access to the requested tool.

If, instead, there are insufficient chips to complete the request, then the chips accounting manager determines whether new chips can be activated from the new chips pool and added to the chips cache pool. If new chips can be activated, then enough new chips are activated to bring the total number of activated chips in the chips cache pool to the minimum required to complete the request. The request is then forwarded to the license manager which draws the necessary chips from the chips cache pool and grants access to the requested tool.

In accordance with an embodiment, if there are insufficient chips in the chips cache pool and new chips cannot be activated, then the request is denied, and an explanatory message is displayed to the user.

In accordance with an embodiment, the chips accounting manager and the license manager, shown in FIG. 3, can be provided as a single chips accounting and license manager. The chips accounting and license manager is operable to receive license requests for software tools, determine whether to grant the license request, track activated chips, and manage activated chip check-in and checkout. Additionally, when the chips accounting and license manager receives a license request for a software tool, the chips accounting and license manager determines whether the chips cache includes sufficient chips to access the software tool. If there are insufficient chips, the chips accounting and license manager checks whether inactive chips in the chips pool can be activated and added to the chips cache, and if there are sufficient chips, the chips accounting and license manager checks out the sufficient chips from the chips cache and grants access to the software tool.

In accordance with an embodiment, a chips accounting manager, such as that shown in FIG. 3, can be incorporated into a VTBL system that already includes a license manager. The chips accounting manager is operable to receive license requests for software tools and to determine whether to grant the license request. In this embodiment, the chips accounting manager includes a first interface to communicate with a chips pool and a chips cache, and a second interface adapted to communicate with the preexisting license manager in the VTBL system. When the chips accounting manager receives a license request for a software tool, the chips accounting manager determines, using the first interface, whether the chips cache includes sufficient chips to access the software tool. If there are insufficient chips, the chips accounting manager checks, using the first interface, whether inactive chips in the chips pool can be activated and added to the chips cache. If there are sufficient chips, the chips accounting manager notifies, using the second interface, the license manager to check out the sufficient chips from the chips cache and grant access to the software tool.

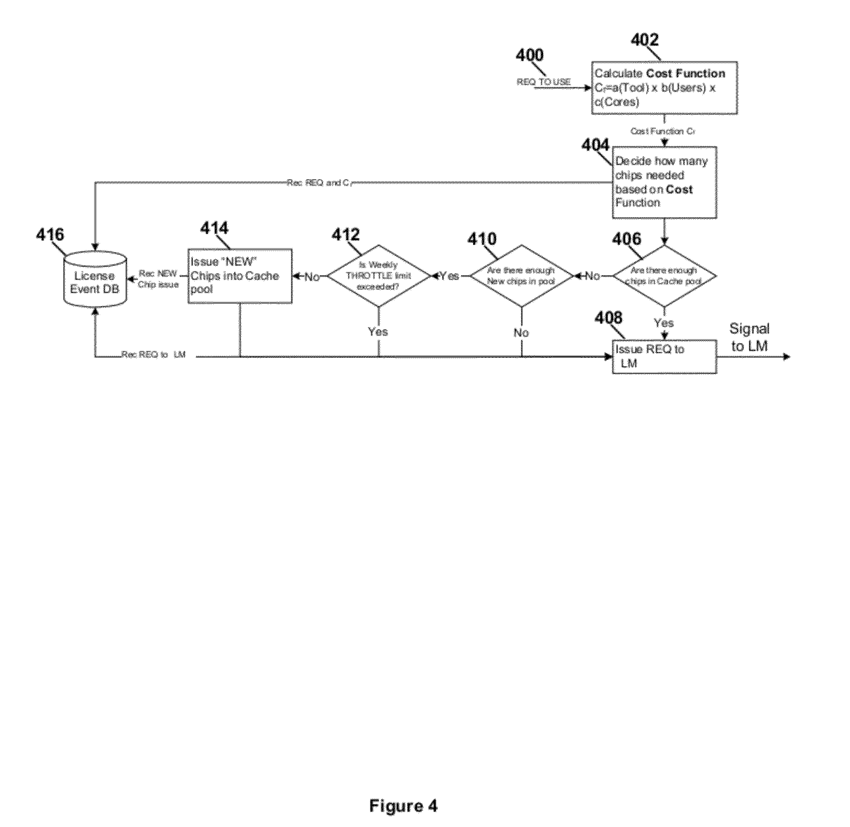

FIG. 4 shows a flow chart illustrating a method of managing chips by a chips accounting manager, in accordance with an embodiment. At step 400, a request for a particular tool is received. At step 402, a cost function is calculated for the problem being solved. In accordance with an embodiment, the cost function can consider several factors, including, for example, the tool being requested, the number of processor cores that will be utilized, and the number of users that will be using the tool. The factors can be equally weighted or each factor can be differently weighted, as needed. At step 404, the cost function is used to determine how many chips are needed to complete the request. At step 406, the system determines whether there are enough chips in the chips cache pool. At step 408, if there are enough chips, then the request is forwarded to the license manager to complete.

At step 410, if there are not enough chips in the chips cache pool, then it is determined whether there are enough chips in the new chips pool. If there are not enough new chips, then processing proceeds to step 408 and the request is forwarded to the license manager (LM). The license manager will then deny the request and can inform the customer that there are insufficient chips.

At step 412, if there are sufficient chips in the new chips pool, then it is determined whether any consumption limits are in place. For example, the customer can set a throttle limit, which limits the rate of consumption over a given period of time. If the throttle limit, or another consumption limit has been reached or exceeded, then processing returns to step 408 and the request is forwarded to the license manager. The license manager will then deny the request and can inform the customer that the consumption limit has been reached. The license manager can also provide the user with instructions for changing the consumption limit.

At step 414, if the consumption limit has not been reached, then enough new chips to service the request are activated and stored in the chips cache pool. At step 416, a license event database receives the request to activate new chips, and activates the new chips. Processing then returns to step 408 and the request is forwarded to the license manager to complete. The license event database can also be used to audit chip usage and consumption which can include a number of diagnostic measurements and other performance metrics that can be provided to the customer.

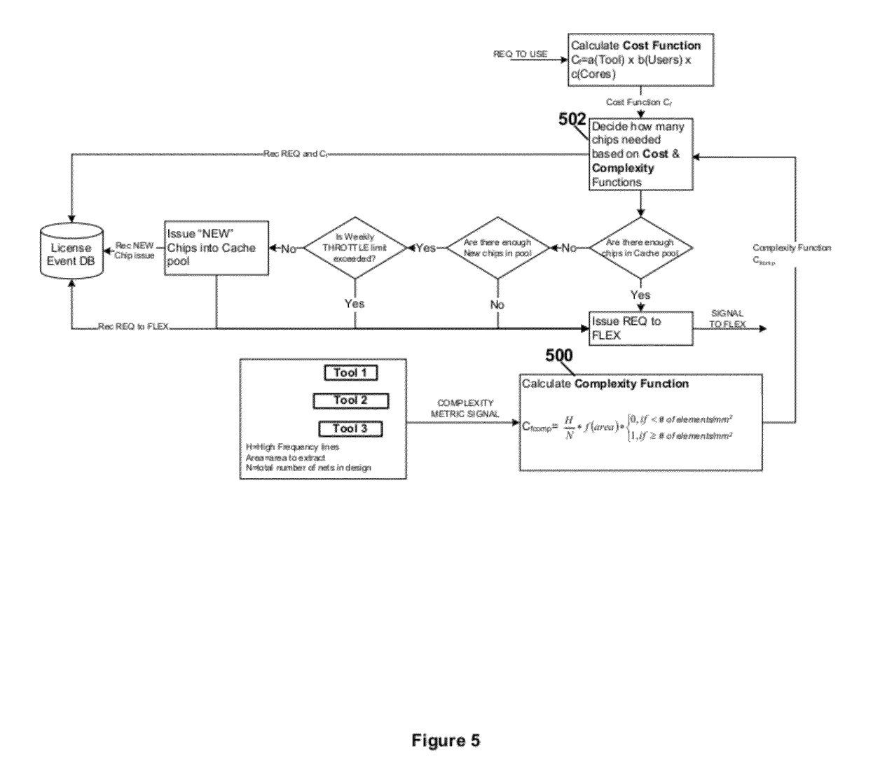

FIG. 5 shows a flow chart illustrating a method of managing chips by a chips accounting manager, in accordance with an embodiment. Processing in FIG. 5 proceeds similarly to that in FIG. 4; however, in addition to a cost function, at step 500 a complexity function is also calculated. In accordance with an embodiment, the complexity function can be based on the tool being used and the complexity of the operation to be performed. For example, simple operations can have a small or zero complexity function, which would minimally affect the number of chips required; while complex operations can have a large complexity function which requires additional chips. An example of one such complexity function is shown in FIG. 5. Although the example shown in FIG. 5 is based on the use of an EDA tool, this is merely one example, and is provided for ease of explanation. One of ordinary skill would recognize that any number of cost functions can be developed on an application by application basis, depending on the tools used and the operations performed. As shown in FIG. 5, one such cost function can include a ratio of high frequency lines (H) to total number of nets in the design (N), multiplied by a function describing the area to be extracted (f(area)). This formula is then applied in a binary manner, depending on the complexity. If the value for H/N*f(area) is greater than a cutoff value, then it serves as the complexity function. If, however, the value for H/N*f(area) is less than a cutoff value, then the design is simple enough that no complexity function need be considered when determining how many chips are required.

At step 502, the number of chips required is determined based on the complexity function and the cost function. The remaining steps proceed similarly to the corresponding steps described above with respect to FIG. 4.

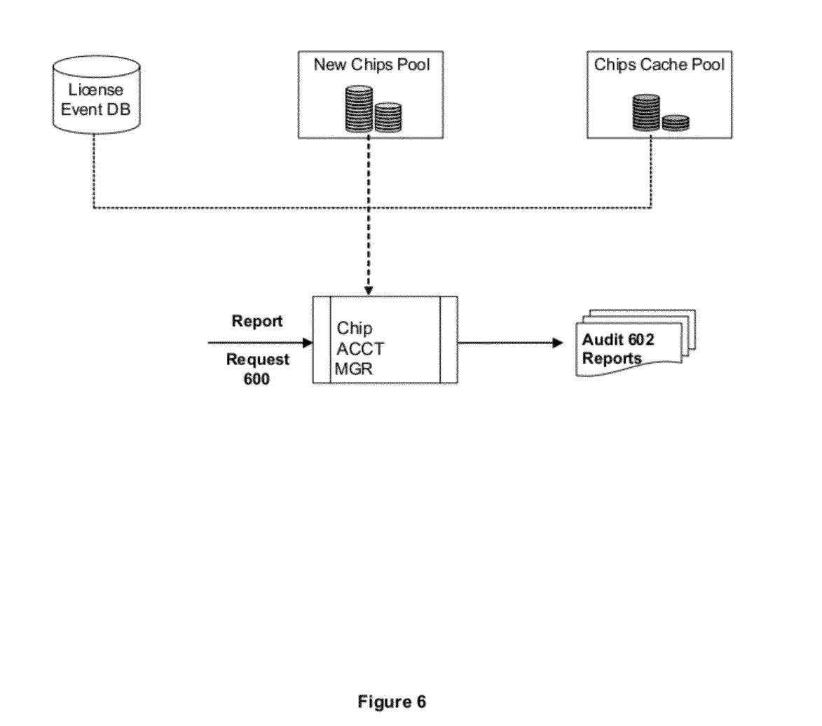

FIG. 6 shows an audit function, in accordance with an embodiment. Audit reports can be requested 600 by the customer through the chips accounting manager. The chips accounting manager can retrieve information from various data sources including the license event database, new chips pool, and chips cache pool, and then compile audit reports which can be provided to the customer 602.

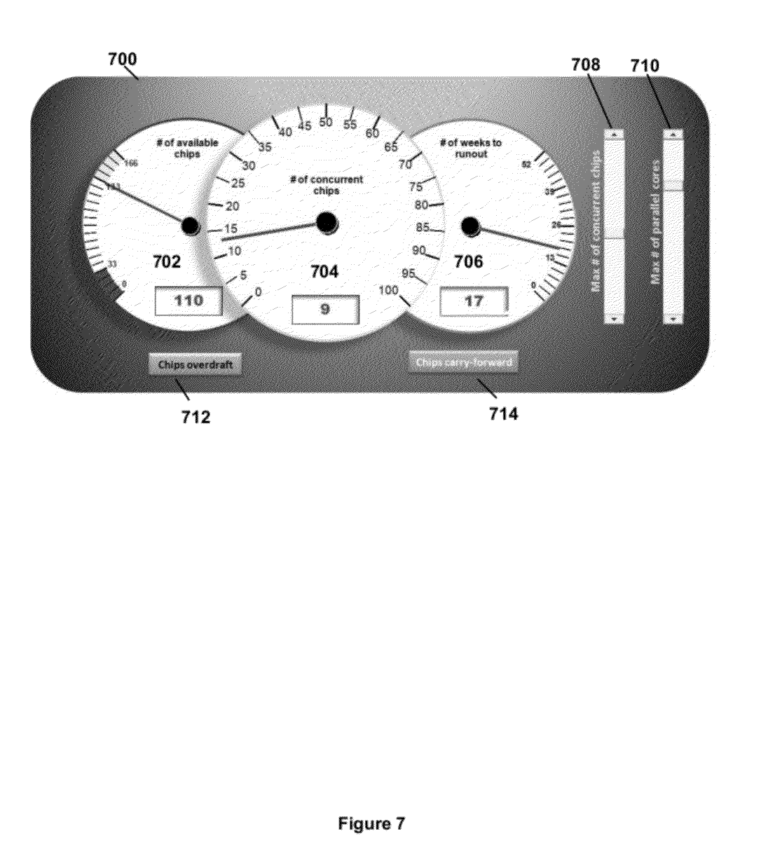

FIG. 7 shows an exemplary graphical user interface (GUI) associated with the licensing system, in accordance with an embodiment. The GUI 700 can serve as a dashboard or cockpit for the customer, providing an overview of current usage, projected usage, and controls for regulating and auditing usage. In the example shown in FIG. 7, three dials are displayed to the user representing the number of chips available 702, the number of concurrent chips 704, and the number of weeks to runout 706. The GUI can communicate with the software licensing system to determine these metrics. Additionally, the GUI displays two slider controls controlling a maximum number of concurrent chips 708 and a maximum number of parallel cores 710. The GUI also displays selectable buttons or icons which indicate chip overdraft settings 712 and chip carry-forward status 714.

In accordance with an embodiment, the number of concurrent chips shows the number of chips that are currently in use by the customer. This can be configured to show the number of chips currently withdrawn and activated, including both chips currently being used to provide access to a software tool and those in the chips cache pool but currently not in use. The number of chips available shows the number of chips in the new chips pool, i.e., the number of chips specified in the contract less the chips which have been activated and/or consumed. The number of weeks to runout estimates how long the new chips will last based on current consumption. The estimate can use an average of consumption over a particular period of time such as the average over the time that the current contract has been in place or the average over the previous month or based on instantaneous usage. Additionally, multiple estimates based on different averages can be provided to the customer in the GUI.

In accordance with an embodiment, the GUI also provides the customer with usage controls that can be used to regulate the customer's chip usage, such as the slider controls shown in FIG. 7. If the customer notices that chip usage is higher than expected, the customer can reduce the number of chips that can be used at any given time which can reduce the rate at which chips are activated and consumed. Additionally, the customer can reduce the number of parallel cores used to execute the software tools. This can similarly reduce the number of chips activated and consumed. Accordingly, the inputs received from the customer can then be used to control the underlying software licensing system to control the rate at which chips are activated and consumed.

In accordance with an embodiment, additional information can be provided to the user through the GUI, such as chips overdraft and chips carry-forward. Chips overdraft can enable the customer to add additional new chips, above the contract-specified number, in accordance with the contract. For example, a customer who buys M chips can be provided the option of purchasing up to an additional N% of M in overdraft chips. Similarly, chips carry-forward can show the customer how many chips of the originally purchased chips can be carried over to a new contract period, if not consumed during the current contract period.

It will be evident that the above example GUI is provided for purposes of illustration and that in accordance with other embodiments, other GUIs can be used and that the GUI is not restricted to the precise examples shown and described above.

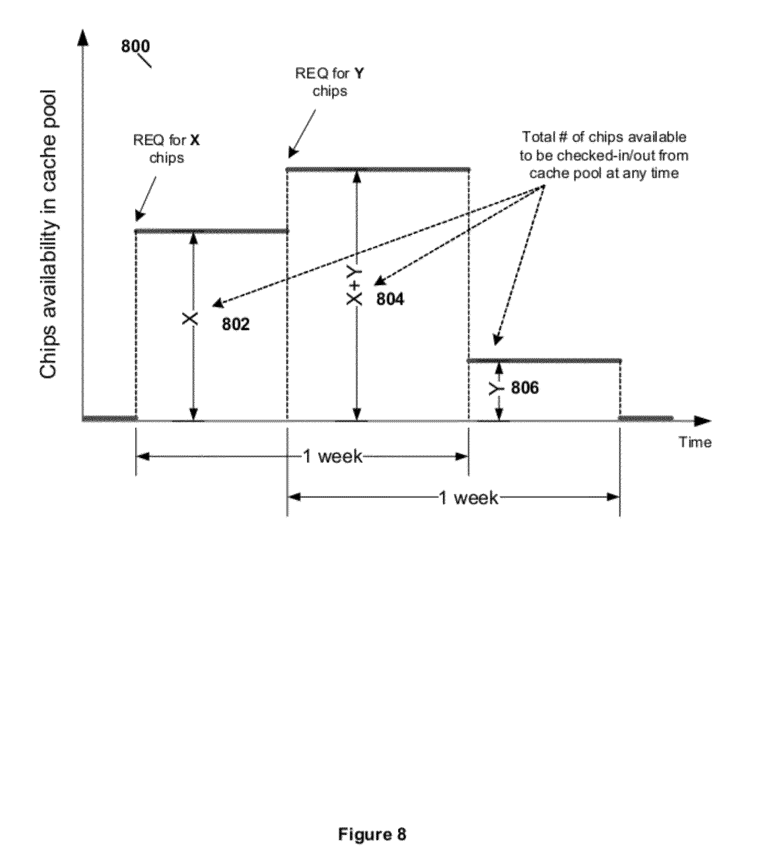

FIG. 8 shows a chips utilization example, in accordance with an embodiment. In FIG. 8, chip availability is graphed versus time 800, showing the number of chips available at any given time. In this example, a request to use a software tool is received, and it is determined that this request requires X chips to be completed. Assuming there are currently zero chips in the chips cache pool, then X chips are activated and stored in the chips cache pool 802. In this example, activated chips expire after one week. As such, these X chips are available for one week, and then are no longer available. After use of the software tool is complete, the chips are returned to the chips cache pool until they are either reused or they expire.

If a second request is received which requires Y chips, and the X chips are in use, then an additional Y chips can be activated and added to the chips cache pool. This brings the total chips stored in the chips cache pool to X+Y 804. When the X chips expire, they are deactivated and removed from the chips cache pool, leaving only the Y chips behind 806. The remaining Y chips will remain in the chips cache pool again until they are either reused or they expire.

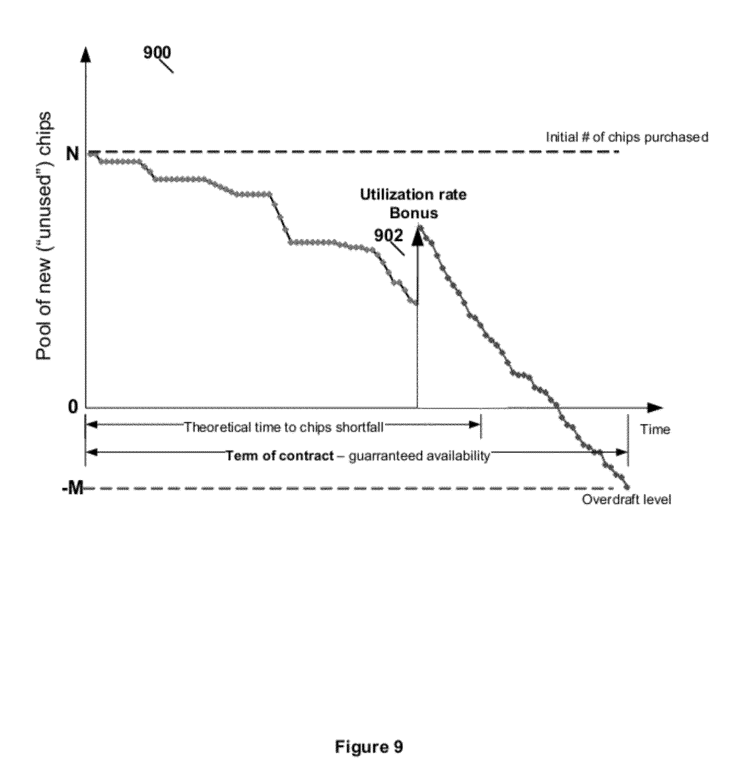

FIG. 9 shows an example of a utilization bonus, in accordance with an embodiment. In FIG. 9, a graph 900 is shown of chips in the new chips cache over time. At time zero, there are N chips in the new chips cache, the value of N is specified by contract with the customer. Additionally, the contract specifies an overdraft amount of M chips. As such, over the course of the contract, the customer has N+M chips available for use. If, during the contract period, it is determined that the customer is likely to run out of chips before the end of the contract period, a usage bonus can be applied to the customer's account. A one time deposit, as shown at 902, can be added to extend the projected runout time to the end of the contract period. This one time deposit can be added at the discretion of the software tool developer, the license manager, or specified in the contract based on various usage metrics and actual consumption rates.

Although the present invention has been described above with particularity to the field of electronic design automation (EDA) software and EDA licensing and license managers, it can equally be applied to any type of software and software licensing environment.

The present invention can be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a computer readable storage medium (media) having instructions stored thereon/in which can be used to program a computer to perform any of the processes of the present invention. The computer readable storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. Many modifications and variations will be apparent to the practitioner skilled in the art. Particularly, other GUIs and metrics for analyzing cost, complexity and usage statistics can be used. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A software licensing system, comprising:
a computer including a computer readable medium and processor operating thereon;
a chips cache which stores activated chips;
a chips pool which stores inactive chips;
a chips accounting manager, operable to receive license requests for software tools and to determine whether to grant the license request;
a license manager which tracks active chips and manages activated chip check-in and checkout;
wherein when the chips accounting manager receives a license request for a software tool the chips accounting manager
determines whether the chips cache includes sufficient chips to access the software tool,
if there are insufficient chips, checks whether inactive chips in the chip pool can be activated and added to the chips cache, and
if there are sufficient chips, notifies the license manager to check out the sufficient chips from the chips cache and grant access to the software tool.

2. The software licensing system of claim 1, further comprising:
a graphical user interface that displays usage statistics and provides usage controls.

3. The software licensing system of claim 1, wherein the chips accounting manager is further operable to:
determine how many chips are needed to access the software tool based on one or more of a cost function for the software tool based on a number of processor cores used, and a complexity function for an operation being performed by the software tool.

4. The software licensing system of claim 1 wherein the chips accounting manager tracks consumption of the chips and creates audit reports.

5. The software licensing system of claim 1 wherein the chips accounting manager is further operable to:
determine that the chips pool is running out of inactive chips; and
add a predetermined number of inactive chips to the chips pool.

6. A software licensing system, comprising:
a computer including a computer readable medium and processor operating thereon;
a chips cache which stores activated chips;
a chips pool which stores inactive chips;
a chips accounting and license manager, operable to
receive license requests for software tools,
determine whether to grant the license request,
track activated chips, and
manage activated chip check-in and checkout;
wherein when the chips accounting and license manager receives a license request for a software tool the chips accounting and license manager
determines whether the chips cache includes sufficient chips to access the software tool,
if there are insufficient chips, checks whether inactive chips in the chips pool can be activated and added to the chips cache,
if there are sufficient chips, checks out the sufficient chips from the chips cache and grants access to the software tool.

7. The software licensing system of claim 6, further comprising:
a graphical user interface that displays usage statistics and provides usage controls.

8. The software licensing system of claim 6, wherein the chips accounting and license manager is further operable to:
determine how many chips are needed to access the software tool based on one or more of a cost function for the software tool based on a number of processor cores used, and a complexity function for an operation being performed by the software tool.

9. The software licensing system of claim 6 wherein the chips accounting and license manager tracks consumption of the chips and creates audit reports.

10. The software licensing system of claim 6 wherein the chips accounting and license manager is further operable to:
determine that the chips pool is running out of inactive chips; and
add a predetermined number of inactive chips to the chips pool.

11. The software licensing system of claim 6 wherein the chips accounting and license manager comprises a chips accounting manager and a license manager.

12. A software licensing system, comprising:
a computer including a computer readable medium and processor operating thereon;
a chips accounting manager, executing on the computer, operable to receive license requests for software tools and to determine whether to grant the license request, wherein the chips accounting manager includes
a first interface to communicate with a chips pool and a chips cache, and
a second interface adapted to communicate with a license manager;
wherein when the chips accounting manager receives a license request for a software tool the chips accounting manager
determines, using the first interface, whether the chips cache includes sufficient chips to access the software tool,
if there are insufficient chips, checks, using the first interface, whether inactive chips in the chips pool can be activated and added to the chips cache,
if there are sufficient chips, notifies, using the second interface, the license manager to check out the sufficient chips from the chips cache and grant access to the software tool.

13. The software licensing system of claim 12, further comprising:
a graphical user interface that displays usage statistics and provides usage controls.

14. The software licensing system of claim 12, wherein the chips accounting manager is further operable to:
determine how many chips are needed to access the software tool based on one or more of a cost function for the software tool based on a number of processor cores used, and
a complexity function for an operation being performed by the software tool.

15. The software licensing system of claim 12 wherein the chips accounting manager tracks consumption of the chips and creates audit reports.

16. The software licensing system of claim 12 wherein the chips accounting manager is further operable to:
determine that the chips pool is running out of inactive chips; and
add a predetermined number of inactive chips to the chips pool.

17. A method for managing software licenses in a software licensing system, comprising:
storing activated chips in a chips cache;
storing inactive chips in a chips pool;
receiving, at a chips accounting manager, license requests for software tools, wherein the chips accounting manager is adapted to communicate with a license manager which controls access to one or more software tools;
wherein when the chips accounting manager receives a license request for a software tool the chips accounting manager
determines whether the chips cache includes sufficient chips to access the software tool,
if there are insufficient chips, checks whether inactive chips in the chip pool can be activated and added to the chips cache,
if there are sufficient chips, notifies the license manager to check out the sufficient chips from the chips cache and grant access to the software tool.

18. The method of claim 17, further comprising:
displaying usage statistics and providing usage controls in a graphical user interface.

19. The method of claim 17, wherein the chips accounting manager is further operable to:
determine how many chips are needed to access the software tool based on one or more of a cost function for the software tool based on a number of processor cores used, and a complexity function for an operation being performed by the software tool.

20. The method of claim 17 wherein the chips accounting manager tracks consumption of the chips and creates audit reports.

21. The method of claim 17 wherein the chips accounting manager is further operable to:
determine that the chips pool is running out of inactive chips; and
add a predetermined number of inactive chips to the chips pool.

22. A computer readable storage medium including instructions stored thereon for managing software licenses in a software licensing system, that when executed by a computer cause the computer to:
store activated chips in a chips cache;
store inactive chips in a chips pool;
receive, at a chips accounting manager, license requests for software tools, wherein the chips accounting manager is adapted to communicate with a license manager which controls access to one or more software tools;
wherein when the chips accounting manager receives a license request for a software tool the chips accounting manager
determines whether the chips cache includes sufficient chips to access the software tool,
if there are insufficient chips, checks whether inactive chips in the chip pool can be activated and added to the chips cache,
if there are sufficient chips, notifies the license manager to check out the sufficient chips from the chips cache and grant access to the software tool.

23. The computer readable storage medium of claim 22, further comprising:
displaying usage statistics and providing usage controls in a graphical user interface.

24. The computer readable storage medium of claim 22, wherein the chips accounting manager is further operable to:
determine how many chips are needed to access the software tool based on one or more of a cost function for the software tool based on a number of processor cores used, and a complexity function for an operation being performed by the software tool.

25. The computer readable storage medium of claim 22 wherein the chips accounting manager tracks consumption of the chips and creates audit reports.

26. The computer readable storage medium of claim 22 wherein the chips accounting manager is further operable to:
determine that the chips pool is running out of inactive chips; and
add a predetermined number of inactive chips to the chips pool.

27. A software licensing management system comprising:
a computer, including a computer readable medium and processor operating thereon; and
a graphical user interface (GUI) configured to
determine, from a software licensing system executing on the computer, a number of available chips, a number of chips in use, and an estimate of time to runout,
display representations of the number of available chips, the number of chips in use, and the estimate of time to runout,
receive an input to control the number of chips in use, and
control the software licensing system based on the input.

28. The software licensing management system of claim 27 wherein the GUI is presented as a dashboard.

29. The software licensing management system of claim 27 wherein the estimate of time to runout can be based on one or more of an average usage and an instantaneous usage.

30. The software licensing management system of claim 27 wherein the input to control the number of chips in use comprises one or more of a maximum number of chips that can be in use concurrently, and a maximum number of processing cores that can be used by software tools controlled by the software licensing system.
